(19) United States
(12) Patent Application Publication
(10) Pub. No.: US 2025/0103351 A1
(43) Pub. Date: Mar. 27, 2025

(54) DECOUPLED RUNTIMES FOR CONTAINER ORCHESTRATION

(71) Applicant: Capital One Services, LLC, McLean, VA (US)

(72) Inventors: Louis ALEXANDER, Glen Allen, VA (US); Damian Neville REEVES, McLean, VA (US)

(73) Assignee: Capital One Services, LLC, McLean, VA (US)

(21) Appl. No.: 18/474,128

(22) Filed: Sep. 25, 2023

(51) Int. Cl. G06F 9/445

(52) U.S. Cl. CPC G06F 9/44505

(57) ABSTRACT

A method and related system for decoupling runtimes of software dependencies includes operations to obtaining, in a first runtime of a first application executing in the first runtime, a command to execute a second application. The operations also include detecting an identifier in metadata associated with the second application and executing a second runtime in a container based on a runtime build identified by the identifier. The operations also include executing the second application in the second runtime.

### SUMMARY

Modern computing systems use containers to package applications and associated dependencies. Containers may be distributed across multiple machines and may provide a means of scaling applications or processes. When performing operations with an application stored in a container, the container may execute both the application itself and a runtime, where some embodiments may use the runtime environment parameters.

In many cases, as the number of applications for a related set of services reliant on a core framework grow, changes in a system runtime may become onerous for application developers to keep up with. In many cases, a runtime may be updated from a previous version to a new version to add or support new features in a core set of applications. While these updates to a runtime version may provide additional features for a core framework, such changes may be of little use to a dependent application reliant on this core set of applications. Even worse, many of these applications that had successfully relied on the previous version of the runtime environment may operate inefficiently or not at all due to the changes made to environment variables or available processes in the new environment.

Some embodiments may overcome these limitations or other technical limitations by using a separate container runtime for applications of different containers. For example, some embodiments may initialize a primary application in the first container runtime for the first container. The first container may execute core applications forming a platform that is usable to execute other applications. In response to initializing the primary application, some embodiments may determine that a first auxiliary application and a second auxiliary application are software dependencies of the primary application. Some embodiments may then obtain a set of commands to execute a set of the auxiliary applications. Some embodiments may then access first metadata associated with the first auxiliary application and second metadata associated with the second auxiliary application to detect that a first runtime identifier is associated with the first auxiliary application and that a second runtime identifier is associated with the second auxiliary application.

Some embodiments may then retrieve a first runtime build identified by the first runtime identifier and a second runtime build identified by the second runtime identifier. Some embodiments may then initialize different containers for each of the auxiliary applications such that a second container executes the first runtime build and a third container executes the second runtime build to prepare the second container for executing the first auxiliary application and to prepare the third container for executing the second auxiliary application. Some embodiments may then execute the first auxiliary application in the second container runtime and the second auxiliary application in the third container runtime such that three decoupled runtimes may be concurrently executing to permit the first application to execute correctly in the first container.

Various other aspects, features, and advantages will be apparent through the detailed description of this disclosure and the drawings attached hereto. It is also to be understood that both the foregoing general description and the following detailed description are examples and not restrictive of the scope of the invention.

### BRIEF DESCRIPTION OF THE DRAWINGS

Detailed descriptions of implementations of the present technology will be described and explained through the use of the accompanying drawings.

FIG. 1 illustrates an example system to initiate disjointed runtime environments for dependency applications, in accordance with some embodiments.

FIG. 2 illustrates an example architecture capable of executing different runtime environments, in accordance with some embodiments.

FIG. 3 illustrates an example conceptual diagram indicating operations to build and deploy a runtime, in accordance with some embodiments.

FIG. 4 illustrates an example conceptual diagram indicating operations to deploy applications reliant on a runtime, in accordance with some embodiments.

FIG. 5 is a flowchart of operations for an exemplary method to detect anomalies in datasets, in accordance with one or more embodiments.

The technologies described herein will become more apparent to those skilled in the art by studying the detailed description in conjunction with the drawings. Embodiments of implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

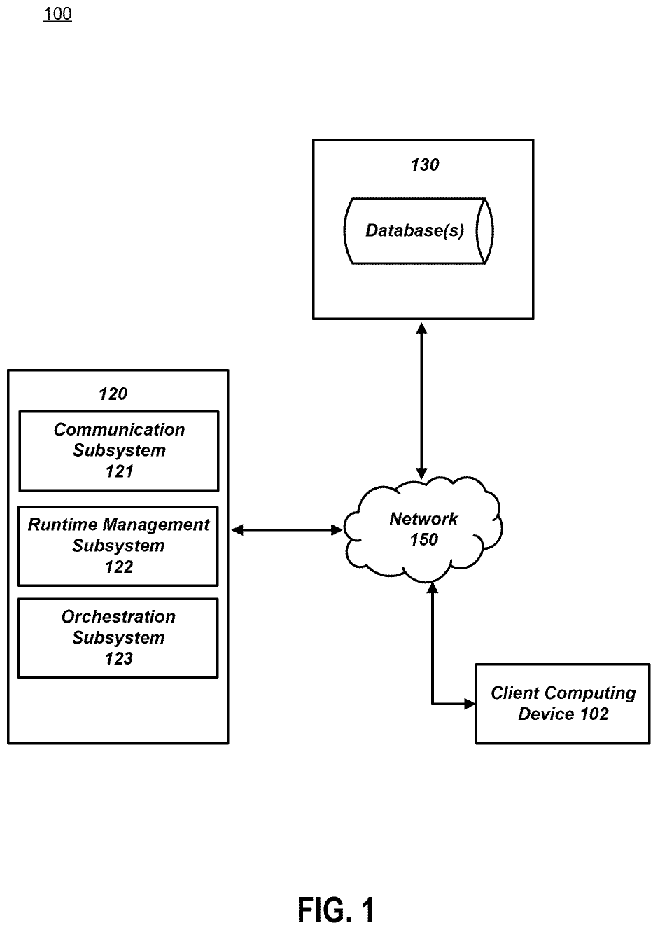

FIG. 1 illustrates an example system to initiate disjointed runtime environments for dependency applications, in accordance with some embodiments. A system 100 includes a client computing device 102. While shown as a laptop computer, it should be noted that the client computing device 102 may include other types of computing devices such as a desktop computer, a wearable headset, a smartwatch, another type of mobile computing device, etc. In some embodiments, the client computing device 102 may communicate with various other computing devices via a network 150, where the network 150 may include the Internet, a local area network, a peer-to-peer network, etc.

The client computing device 102 may send and receive messages through the network 150 to communicate with a set of servers 120, where the set of servers 120 may include a set of non-transitory storage media storing program instructions to perform one or more operations of subsystems 121-123. While one or more operations are described herein as being performed by particular components of the system 100, those operations may be performed by other components of the system 100 in some embodiments. For example, one or more operations described in this disclosure as being performed by the set of servers 120 may instead be performed by the client computing device 102.

Furthermore, some embodiments may communicate with an application programming interface (API) of a third-party service via the network 150 to perform various operations disclosed herein, such as initializing a container, executing a runtime, or performing other operations described in this disclosure. For example, some embodiments may use an API to access cloud-computing infrastructure and execute multiple container runtime builds having different versions. As used in this disclosure, executing a runtime may including executing a runtime build of the runtime, where a runtime build for a runtime may be a version of the runtime that includes compiled versions of a runtime library of the runtime. For example, a runtime build may be or include a set of executable binaries representing one or more runtime libraries of a runtime.

In some embodiments, the set of computer systems and subsystems illustrated in FIG. 1 may include one or more computing devices having electronic storage or otherwise capable of accessing electronic storage, where the electronic storage may include the set of databases 130. The set of databases 130 may include values used to perform operations described in this disclosure. Data stored in the set of databases 130 may include values generated or used by different applications, values used for different runtime environments, values used for different containers, etc. For example, data objects of the set of databases 130 may include a set of records to be used as input records, input feature values, a set of explainability parameters, etc.

In some embodiments, the communication subsystem 121 may retrieve information such as model parameters of a prediction model, obtain values for an explainability model, obtain predetermined explainability parameters, etc. For example, the communication subsystem 121 may obtain a set of input feature values provided by the client computing device 102. The communication subsystem 121 may further send instructions to perform one or more actions or send data to other computing devices, such as the client computing device 102. For example, some embodiments may send one or more summarizations generated by the set of servers 120 to the client computing device 102.

In some embodiments, a runtime management subsystem 122 may store or retrieve one or more runtimes to execute a set of applications. For example, the runtime management subsystem 122 may receive variables for a runtime environment or receive updates to a runtime environment corresponding with a new version of a runtime. The runtime management subsystem 122 may then generate a runtime build based on obtained variables, updates, or other values to generate one or more runtime builds. The runtime management subsystem 122 or another subsystem may then update a set of application metadata to identify that the runtime builds are available and what applications are associated with what runtime builds. For example, some embodiments may update a data table that associates each respective application of a set of different applications with a corresponding respective runtime build identifier that identifies a respective runtime of a set of different runtimes.

In some embodiments, an orchestration subsystem 123 may obtain commands to execute applications, where such applications may include commands provided by users, third-party systems, other applications, etc. For example, the orchestration subsystem 123 may obtain a first command to execute a primary application executing in a first container, where the primary application may use one or more variables set in the first container's runtime. The runtime environment for the first computer may be shared between multiple applications, such as a core set of applications used to orchestrate or otherwise manage other applications. Furthermore, as will be discussed elsewhere in this disclosure, the orchestration subsystem 123 may initialize additional containers to perform operations for applications, where one or more of the additional containers may use different runtime builds from other runtime builds in other containers.

In some embodiments, the orchestration subsystem 123 may receive instructions to execute a primary application, where the primary application may depend on one or more auxiliary applications acting as a set of software dependencies of the primary application. In some embodiments, an auxiliary application may have been created and compiled for a runtime environment that is different than the runtime environment relied upon by the primary application using the auxiliary application. The orchestration subsystem 123 may refer to a metadata for the set of auxiliary applications (e.g., a table or other data structure) to determine which runtime to use for one or more auxiliary applications.

The orchestration subsystem 123 may detect a first runtime build identifier in an obtained set of commands and match the build identifier with a specified runtime build stored into a runtime build repository by the runtime management subsystem 122. For example, some embodiments may determine that metadata associated with a runtime build stored in the runtime repository includes the runtime build identifier “2.1” and matches with the runtime build identifier “2.1” communicated via a command. In some embodiments, the orchestration subsystem 123 may then initialize a container to execute an auxiliary application in the container, where the orchestration subsystem 123 may first execute a container runtime corresponding with the retrieved container build.

After executing the container runtime in the newly initialized container, the orchestration subsystem 123 may then execute an auxiliary application in the container runtime. Furthermore, the orchestration subsystem 123 may perform such operations for multiple applications or multiple containers. For example, the orchestration subsystem 123 may receive a first command to execute a first primary application and, as a result of initializing the first primary application, receive a set of commands to execute a set of auxiliary applications that act as software dependencies of the primary application. The orchestration subsystem 123 may then initialize a first container with a first container runtime build and a second container with a second container runtime build, where the runtime builds of the different containers may be different versions of each other or may be otherwise different from each other or the container runtime of a set of core applications.

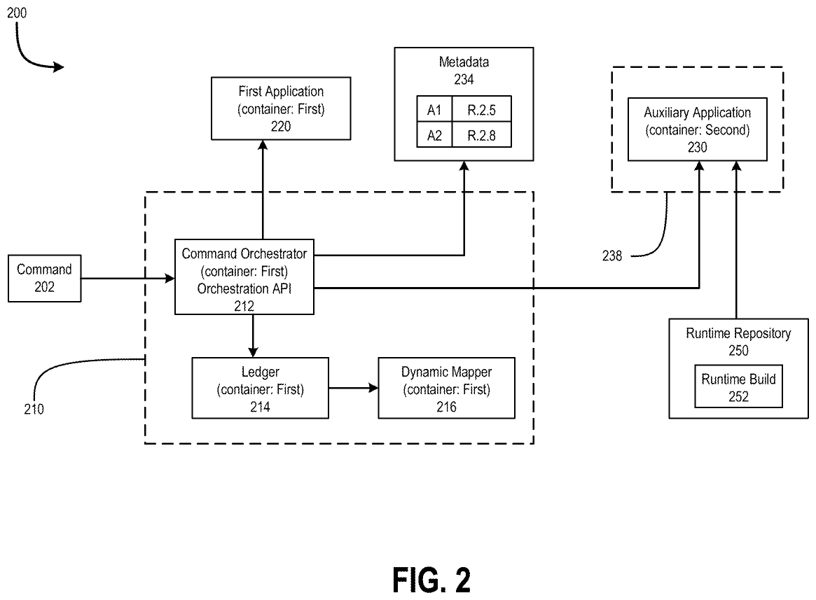

FIG. 2 illustrates an example architecture capable of executing different runtime environments, in accordance with some embodiments. The architecture 200 shows a representation of different applications and their corresponding relationships with each other executing on shared or different containers. In some cases, a collection of applications may be executing in a first container 210. One or more applications executing in the first container 210 may represent a set of primary applications that other applications may rely upon to perform operations correctly and in a target order. For example, a command orchestrator 212 may orchestrate the operations of other applications in the architecture 200, such as a ledger application 214 or a dynamic mapper application 216. The command orchestrator 212 may receive commands, such as a command 202, handle inbound mapping operations, or handle responses to inbound mapping operations. In some embodiments, the command orchestrator 212 controls what application records are in use, which fields are stored in each corresponding application record, how to validate or map from request fields to these stored fields, etc.

In some embodiments, for each respective supported application of a set of supported applications that can be executed, the ledger application 214 may execute command logic associated with the respective supported application. The command logic may include logic that controls a list of commands supported by the respective supported application, what fields (e.g., a data field for a particular application stored in a container environment) may be present in the ledger for that supported application, or what behavior is used to update those data fields when a command (e.g., a command received by the command orchestrator 212) is executed. Additionally, the dynamic mapper application 216 may control what events are produced after a command is executed, what fields should be accessed, updated, available, or created for those events, and a data source for those fields (e.g., an identifier of a data table, an identifier of another type of data structure, a specific record, etc.). The applications executing in the first container 210 are executing in a shared container runtime of the first container 210.

The command orchestrator 212 or another component of the first container 210 may receive a command 202 that calls for the initiation of a first application 220 that depends on an auxiliary application 230, where the auxiliary application 230 may be labeled with the identifier “A1.” In response, the command orchestrator 212 or another component executing in the first container may execute operations in the runtime environment of the first container 210 to initialize the first application 220. For example, the command orchestrator 212 may load data for the first application 220 (e.g., retrieved from long-term storage memory or from a cache), where such data may include a configuration file of the first application 220. Some embodiments may determine that the first application 220 indicates a dependency on the auxiliary application 230 based on a configuration file of the first application 220, metadata associated with the first application 220, or other parameter associated with the first application 220.

In response to determining that the first application 220 indicates that the auxiliary application 230 is a software dependency, some embodiments may access a set of metadata 234, which may indicate an identifier of a runtime or an identifier of a runtime build associated with the auxiliary application 230, which may be labeled as “A1.” The set of metadata 234 may indicate a first runtime “R.2.5” in association with the auxiliary application 230 by associating “R.2.5” and “A1” in a record of the set of metadata 234. Some embodiments may access the set of metadata 234, which may include a data table, a data object, a tree, or some other data structure. Some embodiments may then search a runtime repository 250 for a runtime build mapped to the identifier “R.2.5” to retrieve a runtime build 252. Some embodiments may then initialize a second container 238, execute the runtime build 252 in the second container 238, and then execute the auxiliary application 230 in the second container 238. The second container 238 may then provide outputs or other results of the auxiliary application 230 or other applications executing in the second container 238 back to the first application 220.

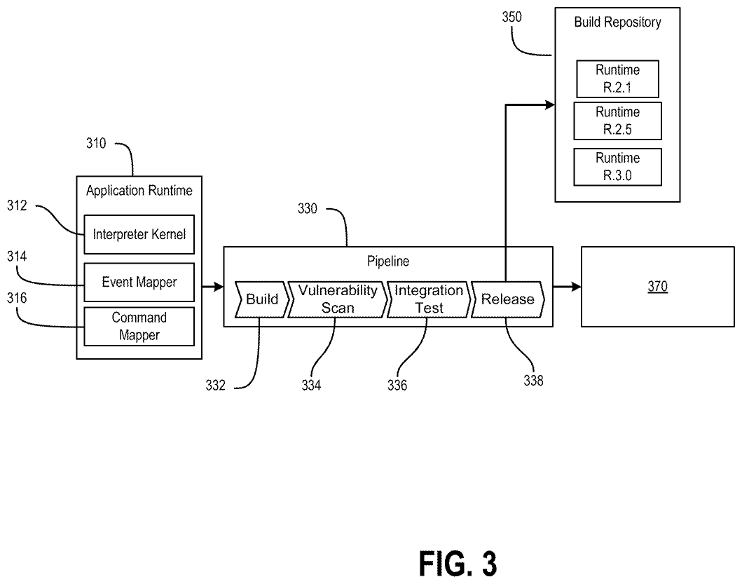

FIG. 3 illustrates an example conceptual diagram indicating operations to build and deploy a runtime, in accordance with some embodiments. An application runtime source code 310 may include code for various components necessary for various operations expected to be executed in the runtime. For example, the application runtime source code 310 includes program code for an interpreter kernel component 312 to instantiate execution models for application logic or to provide interoperability between different containers or runtimes. The application runtime source code 310 also includes program code for an event mapper component 314 to perform operations related to a dynamic mapper and program code for a command mapper component 316 to perform operations related to a command orchestrator or other operations to transform inbound commands into interpretable instructions.

Some embodiments may provide the application runtime source code 310 to a pipeline system 330. The pipeline system 330 may include a build subsystem 332 to compile the application runtime source code 310 to generate a runtime build, a vulnerability scan subsystem 334 to scan the runtime build for vulnerabilities in the build subsystem 332, and an integration testing subsystem 336 to test integration between the runtime build and other components. The pipeline system 330 may also include a release subsystem 338, where an output of the release subsystem 338 may be sent to a runtime build repository 350 or may be deployed to a container 370.

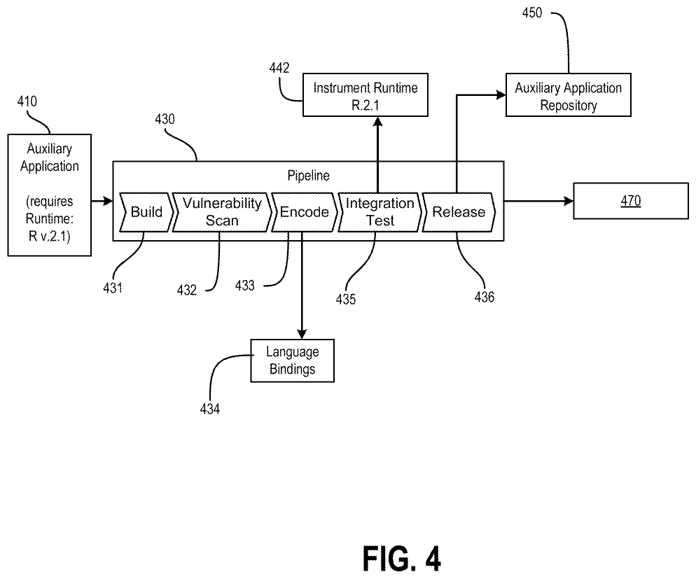

FIG. 4 illustrates an example conceptual diagram indicating operations to deploy applications reliant on a runtime, in accordance with some embodiments. An auxiliary application source code 410 may program code for an auxiliary application and may be configured to be compatible with a first runtime “R.2.1.” Some embodiments may provide the auxiliary application source code 410 to a pipeline system 430. The pipeline system 430 may include a build subsystem 431 to compile the auxiliary application source code 410 to generate an auxiliary application build, a vulnerability scan subsystem 432 to scan the auxiliary application build for vulnerabilities in the vulnerability scan subsystem 432, and an encoding subsystem 433 to encode the auxiliary application build to include or otherwise be associated with a set of language bindings 434. The pipeline system 430 may also include an integration testing subsystem 435 to test integration between the auxiliary application build and other components, where the integration testing subsystem 435 may retrieve the runtime build 442 as a part of the integration testing process. The pipeline system 430 may also include a release subsystem 436, where an output of the release subsystem 436 may be sent to an auxiliary application build repository 450 or may be deployed to a container 470.

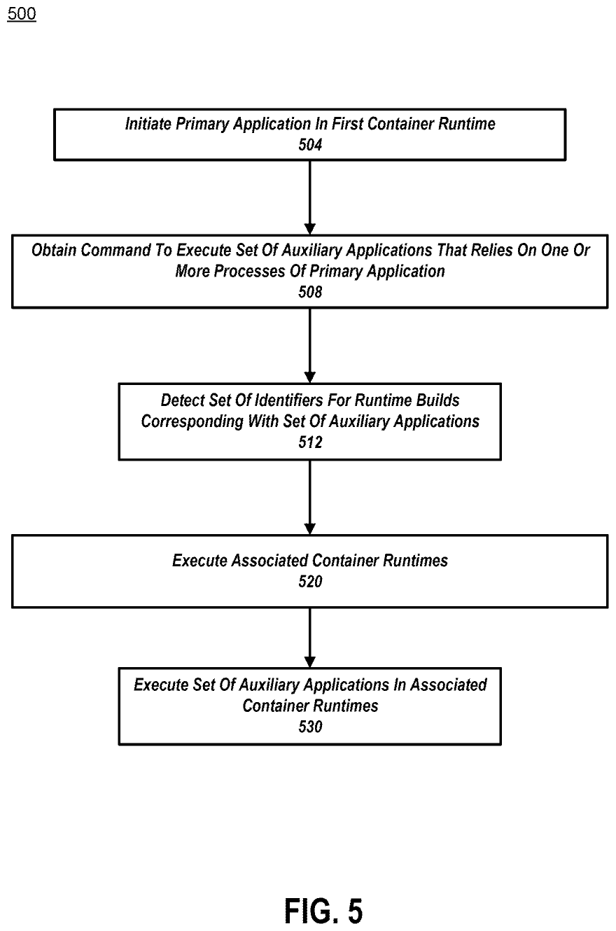

FIG. 5 is a flowchart of operations for an exemplary method to detect anomalies in datasets, in accordance with one or more embodiments. In some embodiments, a primary application may be initiated in a first container runtime of a first container, as indicated by block 504. In some embodiments, the primary application may be one of a set of core applications that is part of a framework used by multiple other auxiliary applications. In many instances, the runtime upon which the set of core applications relies may be different from the runtimes used by one or more auxiliary applications. For example, a core set of primary applications may rely on a build version 2.5 of a runtime, while other auxiliary applications may rely on a build version 2.1 of the runtime.

In some embodiments, the first container runtime may be relied upon to execute a set of primary applications that form a platform capable of managing other applications. For example, the first container may be used to execute a core set of primary applications such as an orchestrator component, a ledger component, and a mapping component. This core set of primary applications may be components of a platform hosted in the first container, where the platform is capable of executing other applications in response to scheduled operations, user input, or other input.

In some embodiments, the runtime builds stored in a runtime repository may have been encoded based on a set of language bindings compatible with a core set of primary applications. For example, if a core set of primary applications is written to be compatible with a first programming language, some embodiments may encode a runtime build to include a set of language bindings compatible with the first programming language. In some embodiments, the source code for the runtime build may be written in a second programming language, where compiling the source code or some other operation related to generating the runtime build may include operations to include the set of language bindings compatible with the first programming language.

Some embodiments include features to prevent unauthorized initiation of auxiliary applications or other applications. For example, some embodiments may obtain a command to initialize a first application and, in response, determine whether the command includes or is otherwise associated with a set of credentials that satisfy a set of security criteria of the first container. For example, some embodiments may receive a command from a user account and, in response, determine whether a set of credentials of the user account satisfies a set of security criteria. In response to a determination that the set of credentials satisfies the set of security criteria, some embodiments may then perform other operations described in this disclosure related to initializing containers and retrieving a container build in response to the user command.

Some embodiments may obtain a command to execute a set of auxiliary applications that relies on one or more processes of the primary application, as indicated by block 508. Some embodiments may obtain a set of commands to execute one or more auxiliary applications, where the commands may be initiated by a user, a scheduled process, another application, etc. For example, in response to initializing a client application in a first container runtime of a first container that is also being used to execute a core set of primary applications, some embodiments may obtain a set of commands from the client application to execute a first auxiliary application and a second auxiliary application, where outputs of both the first and second auxiliary applications may be used by the client application.

In some embodiments, a command to execute a set of auxiliary applications may themselves be a result of commands to execute other auxiliary applications. For example, in response to receiving a command to initialize a first application, some embodiments may retrieve a configuration file associated with the first application and identify a first set of auxiliary applications that are relied upon by the first application. Some embodiments may then attempt to execute a first set of auxiliary applications and, in the process, retrieve configuration files of the first set of auxiliary applications. Some embodiments may then identify a second set of identifiers corresponding with the second set of auxiliary applications and initialize operations to execute this second set of auxiliary applications.

Some embodiments may detect a set of identifiers for runtime builds corresponding with the set of auxiliary applications, as indicated by block 512. In some embodiments, a computer system, managing application, other managing entity may perform operations to retrieve one or more identifiers of runtimes associated with auxiliary applications. As described elsewhere, some embodiments may execute client applications or other applications that are to be run in a first runtime environment, where the client or other applications rely on auxiliary applications that rely on a different runtime environment. For example, some embodiments may execute a first application that requires execution in a runtime “R.2.1” and determine that the first application requires a first auxiliary application. Some embodiments may then retrieve a configuration file of the first auxiliary application and determine that the runtime associated with the first auxiliary application is identified by the name “R.3.0.”

In some embodiments, the set of identifiers for runtime builds may be or include identifiers for a general type of runtime. For example, an identifier for a runtime build may include the runtime identifier “R.2.0.” Some embodiments may then perform operations to identify a specific build of a runtime that was built based on source code or other program instructions corresponding with the runtime identifier “R.2.0.” Alternatively, or additionally, the set of identifiers for a runtime build may refer to a specific runtime build, such as by referring to an address of the runtime build.

Some embodiments may execute a set of container runtimes based on the set of identifiers for the runtime builds, as indicated by block 520. As described elsewhere in this disclosure, an auxiliary application may be executed in its own container, where results of the auxiliary application may then be provided to other applications. When executing an auxiliary application in its own container, some embodiments may first execute a corresponding runtime for that container using the identified runtime build for that auxiliary application. For example, after determining a runtime build of a runtime identified by the runtime build identifier “R.2.5,” some embodiments may retrieve this runtime build from a runtime build repository by submitting a query to search the runtime build repository based on the runtime build identifier “R.2.5.” Some embodiments may then initialize a first container and execute the runtime build in the first container.

As described elsewhere in this disclosure, some embodiments may receive a set of commands to execute a plurality of auxiliary applications concurrently. In some embodiments, each auxiliary application of this plurality of auxiliary applications may rely on the same runtime build. For example, some embodiments may initialize a set of containers, where each container of this set of containers will be used to execute a corresponding auxiliary application of the plurality of auxiliary applications. Some embodiments may then retrieve a runtime build from a runtime build repository, where the retrieved runtime build is identified by a configuration file or other parameter associated with the metadata of the plurality of auxiliary applications. Some embodiments may then use this same runtime build to execute instances of the runtime build in each respective container of the set of containers.

In some embodiments, the metadata of a plurality of auxiliary applications may identify different runtime environments. For example, some embodiments may receive, in a first container executing a first runtime, a set of commands to execute a first, second, and third auxiliary application and determine, based on metadata of the plurality of auxiliary applications, that the first auxiliary application requires a second runtime, that the second auxiliary application requires a third runtime, and that the third auxiliary application requires a fourth runtime. In response, some embodiments may retrieve, from a runtime repository, a first runtime build corresponding with the first runtime identifier, a second runtime build corresponding with the second runtime identifier, and a third runtime build corresponding with the third runtime identifier. Some embodiments may initialize a second, third, and fourth container and may then execute a second container runtime in the second container using the first runtime build, execute a third container runtime in the third container using the second runtime build, and execute a fourth container runtime in the fourth container using the third runtime build.

As described elsewhere in this disclosure, some embodiments may execute multiple container runtimes in multiple containers. In some embodiments, different accounts may be associated with different containers. For example, a first account may be associated with a first set of credentials and be used to initialize a first container, and a second account and may be used to initialize a second container. The first container may be configured with the first set of credentials such that only the first account may access the first container. The second container may be configured with the second set of credentials such that only the second account may access the second container. By isolating the controls of different containers, some embodiments may provide additional security features while allowing real-time control of container operations or necessary auxiliary applications to specific users.

Furthermore, some embodiments may control accessibility or management of containers or applications running within containers by setting the account or other user identifier that is associated with runtime builds. For example, some embodiments may deploy a first runtime build that is accessible to a user account and a second runtime build that is not accessible to the same user account. Some embodiments may determine which builds are to be associated with different user accounts based on differences in privilege parameters or other values associated with the different user accounts.

In some embodiments, a system may receive a set of commands in a first container, where the set of commands may cause the system to initialize a second container to execute an auxiliary application in response to receiving the set of commands. In some embodiments, a user may have access to operations within the first container but be restricted from controlling containers that are initialized in response to the set of commands such that the second container is not accessible to the user.

Some embodiments limit the amount of computing resources used by a container, such as a container initialized for executing an auxiliary application. For example, after receiving instructions to execute an auxiliary application, some embodiments may predict a computing resource cost associated with the auxiliary application. Some embodiments may use a prediction model or a statistical model to predict an amount of computing time, memory, processing resource, or other computing resource that will be used to execute an auxiliary application. Furthermore, some embodiments may then use this amount as an anticipated computing resource cost and compare the anticipated computing resource cost with a computing resource threshold. Some embodiments may then be permitted to initialize a container for executing the auxiliary application based on a determination that the computing resource cost does not exceed the computing resource threshold or otherwise does satisfy the computing resource threshold.

In some embodiments, the runtime builds stored in a build repository or other data source may be generated from different source codes, where the different source codes may be different versions of an initial source code. After building the runtime builds from the different source codes, some embodiments may store the runtime builds in a repository that includes an indexing system that maps different runtime builds to different runtime identifiers. For example, some embodiments may compile source code identified by the runtime identifier “R.1.5” to generate a first runtime build identified as “R.1.5-150438Eq1.” Some embodiments may then store the first runtime build into a repository that maps the runtime identifier “R.1.5” with the runtime build identifier “R. 1.5-150438Eq1.” Some embodiments may then receive program instructions to execute a first auxiliary application, where the metadata of the first auxiliary application lists the runtime identifier “R.1.5.” In response, some embodiments may then access the repository and select the runtime build identified by “R.1.5-150438Eq1” based on the runtime identifier “R.1.5.”

Some embodiments may determine that an auxiliary application indicates multiple possible runtime builds. For example, a metadata table may include an entry for an auxiliary application that includes runtime identifiers “R.2.0,” “R.2.5,” and “R.3.0.” Some embodiments may determine a version associated with each of these runtime identifiers and, in response, may select for retrieval a runtime build indicated to be a most recent runtime build. For example, if the runtime identifier “R.3.0” identifies a runtime that is a most recent version relative to the runtimes associated with the runtime identifiers “R.2.0” and “R.2.5,” some embodiments may select the runtime build mapped to the runtime identifier “R.3.0.” Some embodiments may then initialize a container and execute the selected runtime build in an initialized container to prepare the container for executing the auxiliary application.

Alternatively, or additionally, some embodiments may designate different runtimes with different categories in addition to version numbers and select runtimes based on both their category and version numbers. For example, some embodiments may include a repository that distinguishes between runtimes categorized as “stable” and “experimental.” In some embodiments, the metadata for an auxiliary application to be executed may indicate both stable and experimental runtimes. Some embodiments may retrieve a runtime build after determining that the retrieved runtime build is a most recent stable runtime build of the multiple runtime builds stored in the repository. By including logic to select a runtime from a list of compatible runtimes when executing an application, some embodiments may accommodate metadata that may serve multiple purposes. Such accommodations may permit the use of existing metadata instead of requiring new metadata to be generated.

Some embodiments may execute the set of auxiliary applications in their corresponding container runtimes, as indicated by block 530. Some embodiments may retrieve a build version of an auxiliary application to execute the auxiliary application. For example, some embodiments may retrieve an auxiliary application build from a repository and execute the auxiliary application in a container that is concurrently executing or has already initialized a corresponding runtime build identified by metadata of the auxiliary application.

Some embodiments may retrieve application data of the auxiliary application, such as configuration files, media files, compressed data, or other data used to execute the auxiliary application from one or more memory sources designed for fast retrieval or storage. For example, some embodiments may store application data of an auxiliary application into a cache and, after receiving a command to execute the auxiliary application, may retrieve the application data from the cache to load the application data into a container used to execute the auxiliary application. By storing application data of auxiliary applications in a cache, some embodiments may speed up the rate at which auxiliary applications may be used.

Some embodiments may execute a plurality of auxiliary applications in plurality of containers, where at least one auxiliary application of the plurality of auxiliary applications is a dependency of another auxiliary application of the plurality of auxiliary applications. Some embodiments may concurrently initialize containers and execute applications based on this dependency. For example, some embodiments may detect a dependency that a first auxiliary application has on a second auxiliary application, where the first and second auxiliary applications identify a first runtime and a second runtime. Some embodiments may detect this dependency and concurrently initialize a first container and a second container. Some embodiments may then retrieve runtime builds based on runtime identifiers stored in metadata of the first and second auxiliary applications. Furthermore, some embodiments may concurrently initialize a first container and a second container or concurrently execute a first container runtime and a second container runtime based on the first and second runtime builds. Some embodiments may then execute the first auxiliary application in the first container runtime and execute the second auxiliary application in the second container runtime. Some embodiments may then transfer information from the second container to the first container, where the information may include outputs of the second auxiliary application. By permitting concurrent execution of different containers, some embodiments may accommodate the concurrent execution of multiple applications that depend on various numbers of runtimes.

Some embodiments may execute two or more auxiliary applications in a shared container based on a determination that the two or more auxiliary applications identify the same runtime build or a same runtime version. For example, some embodiments may receive, at a first container, a set of instructions to execute a first auxiliary application and a second auxiliary application. Some embodiments may then determine that the metadata for the first auxiliary application and the second auxiliary application each identify the runtime “R.0.5.” In response, some embodiments may retrieve a runtime build mapped to runtime identifier “R.0.5” from a repository and use the runtime build to initialize a runtime environment in a second container. Some embodiments may then execute both the first and second auxiliary applications in the second container.

Some embodiments may arrange an interoperability layer interposed between different containers to permit the different containers to communicate with each other. Such an interoperability layer may address differences between containers, such as differences in timing, parameter values, or other values. The interoperability layer may include one or more applications or other implementations of protocols and may perform operations such as standardizing API calls between different containers or adapting calls into commands understandable for the specific runtime environment of a container.

In some embodiments, the set of auxiliary applications executing in different containers may perform operations to modify a record history. For example, a first application executing in a first runtime may perform operations to update a record history to indicate a history of different events and associate those events with timepoints. In many cases, the record history may be difficult to modify to reflect uncaptured information due to real-time security features concurrently executing in the first runtime or other operational reasons associated with the first runtime. Some embodiments may use an auxiliary application or an application dependent on the auxiliary application executing in a second runtime to receive program instructions to update the record history to include additional data at a timepoint other than the most recent timepoint of the record history. For example, some embodiments may retrieve a first record history representing database transactions associated with a user between Day 0 and Day 10. Some embodiments may then generate a temporary version of the first record history and insert an additional event associated with a timepoint that occurred on Day 5 into the temporary version of the record history. Some embodiments may then update the first record history based on the temporary version of the record history at a later time such that insertion of the event associated with a timepoint on Day 5 will not disrupt the real-time capture of events in the record history. By using different containers to execute this type of time travel feature with respect to record histories, some embodiments allow for additional flexibility in recording changes to a user's activities.

The operations of each method presented in this disclosure are intended to be illustrative and non-limiting. It is contemplated that the operations or descriptions of FIG. 5 may be used with any other embodiment of this disclosure. In addition, the operations and descriptions described in relation to FIG. 5 may be done in alternative orders or in parallel to further the purposes of this disclosure. For example, each of these operations may be performed in any order, in parallel, or simultaneously to reduce lag or increase the speed of a computer system or method. In some embodiments, the methods may be accomplished with one or more additional operations not described, and/or without one or more of the operations discussed. Additionally, the order in which the processing operations of the methods described in this disclosure is not intended to be limiting.

As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety (i.e., the entire portion), of a given item (e.g., data) unless the context clearly dictates otherwise. Furthermore, a “set” may refer to a singular form or a plural form, such that a “set of items” may refer to one item or a plurality of items.

In some embodiments, the operations described in this disclosure may be implemented in a set of processing devices (e.g., a digital processor, an analog processor, a digital circuit designed to process information, an analog circuit designed to process information, a state machine, and/or other mechanisms for electronically processing information). The processing devices may include one or more devices executing some or all of the operations of the methods in response to instructions stored electronically on a set of non-transitory, machine-readable media, such as an electronic storage medium. Furthermore, the use of the term “media” may include a single medium or combination of multiple media, such as a first medium and a second medium. A set of non-transitory, machine-readable media storing instructions may include instructions included on a single medium or instructions distributed across multiple media. The processing devices may include one or more devices configured through hardware, firmware, and/or software to be specifically designed for the execution of one or more of the operations of the methods. For example, it should be noted that one or more of the devices or equipment discussed in relation to FIGS. 1-4 could be used to perform one or more of the operations in FIG. 5.

It should be noted that the features and limitations described in any one embodiment may be applied to any other embodiment herein, and a flowchart or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In some embodiments, the various computer systems and subsystems illustrated in FIG. 1 may include one or more computing devices that are programmed to perform the functions described herein. The computing devices may include one or more electronic storages (e.g., a the set of databases accessible to one or more applications depicted in the system 100), one or more physical processors programmed with one or more computer program instructions, and/or other components. For example, the set of databases may include a relational database such as a PostgreSQL™ database or MySQL database. Alternatively, or additionally, the set of databases or other electronic storage used in this disclosure may include a non-relational database, such as a Cassandra™ database, MongoDB™ database, Redis database, Neo4j™ database, Amazon Neptune™ database, etc.

The computing devices may include communication lines or ports to enable the exchange of information with a set of networks (e.g., a network used by the system 100) or other computing platforms via wired or wireless techniques. The network may include the Internet, a mobile phone network, a mobile voice or data network (e.g., a 5G or Long-Term Evolution (LTE) network), a cable network, a public switched telephone network, or other types of communications networks or combination of communications networks. A network described by devices or systems described in this disclosure may include one or more communications paths, such as Ethernet, a satellite path, a fiber-optic path, a cable path, a path that supports Internet communications (e.g., IPTV), free-space connections (e.g., for broadcast or other wireless signals), Wi-Fi, Bluetooth, near field communication, or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Each of these devices described in this disclosure may also include electronic storages. The electronic storages may include non-transitory storage media that electronically stores information. The storage media of the electronic storages may include one or both of (i) system storage that is provided integrally (e.g., substantially non-removable) with servers or client computing devices, or (ii) removable storage that is removably connectable to the servers or client computing devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). An electronic storage may store software algorithms, information determined by the processors, information obtained from servers, information obtained from client computing devices, or other information that enables the functionality as described herein.

The processors may be programmed to provide information processing capabilities in the computing devices. As such, the processors may include one or more of a digital processor, an analog processor, a digital circuit designed to process information, an analog circuit designed to process information, a state machine, and/or other mechanisms for electronically processing information. In some embodiments, the processors may include a plurality of processing units. These processing units may be physically located within the same device, or the processors may represent the processing functionality of a plurality of devices operating in coordination. The processors may be programmed to execute computer program instructions to perform functions described herein of subsystems 121-123 or other subsystems. The processors may be programmed to execute computer program instructions by software; hardware; firmware; some combination of software, hardware, or firmware; and/or other mechanisms for configuring processing capabilities on the processors.

It should be appreciated that the description of the functionality provided by the different subsystems described herein is for illustrative purposes, and is not intended to be limiting, as any of subsystems 121-123 may provide more or less functionality than is described. For example, one or more of subsystems 121-123 may be eliminated, and some or all of its functionality may be provided by other ones of subsystems 121-123. As another example, additional subsystems may be programmed to perform some or all of the functionality attributed herein to one of subsystems 121-123 described in this disclosure.

With respect to the components of computing devices described in this disclosure, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Further, some or all of the computing devices described in this disclosure may include a user input interface and/or user output interface (e.g., a display) for use in receiving and displaying data. In some embodiments, a display such as a touchscreen may also act as a user input interface. It should be noted that in some embodiments, one or more devices described in this disclosure may have neither user input interface nor displays and may instead receive and display content using another device (e.g., a dedicated display device such as a computer screen and/or a dedicated input device such as a remote control, mouse, voice input, etc.). Additionally, one or more of the devices described in this disclosure may run an application (or another suitable program) that performs one or more operations described in this disclosure.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment may be combined with one or more features of any other embodiment.

As used throughout this application, the word “may” is used in a permissive sense (i.e., meaning having the potential to), rather than the mandatory sense (i.e., meaning must). The words “include,” “including,” “includes,” and the like mean including, but not limited to. As used throughout this application, the singular forms “a,” “an,” and “the” include plural referents unless the context clearly indicates otherwise. Thus, for example, reference to “an element” or “a element” includes a combination of two or more elements, notwithstanding the use of other terms and phrases for one or more elements, such as “one or more.” The term “or” is non-exclusive (i.e., encompassing both “and” and “or”), unless the context clearly indicates otherwise. Terms describing conditional relationships (e.g., “in response to X, Y,” “upon X, Y,” “if X, Y,” “when X, Y,” and the like) encompass causal relationships in which the antecedent is a necessary causal condition, the antecedent is a sufficient causal condition, or the antecedent is a contributory causal condition of the consequent (e.g., “state X occurs upon condition Y obtaining” is generic to “X occurs solely upon Y” and “X occurs upon Y and Z”). Such conditional relationships are not limited to consequences that instantly follow the antecedent obtaining, as some consequences may be delayed, and in conditional statements, antecedents are connected to their consequents (e.g., the antecedent is relevant to the likelihood of the consequent occurring). Statements in which a plurality of attributes or functions are mapped to a plurality of objects (e.g., a set of processors performing steps/operations A, B, C, and D) encompass all such attributes or functions being mapped to all such objects and subsets of the attributes or functions being mapped to subsets of the attributes or functions (e.g., both/all processors each performing steps/operations A-D, and a case in which processor 1 performs step/operation A, processor 2 performs step/operation B and part of step/operation C, and processor 3 performs part of step/operation C and step/operation D), unless otherwise indicated. Further, unless otherwise indicated, statements that one value or action is “based on” another condition or value encompass both instances in which the condition or value is the sole factor and instances in which the condition or value is one factor among a plurality of factors.

Unless the context clearly indicates otherwise, statements that “each” instance of some collection has some property should not be read to exclude cases where some otherwise identical or similar members of a larger collection do not have the property (i.e., each does not necessarily mean each and every). Limitations as to the sequence of recited steps should not be read into the claims unless explicitly specified (e.g., with explicit language like “after performing X, performing Y”) in contrast to statements that might be improperly argued to imply sequence limitations (e.g., “performing X on items, performing Y on the X'ed items”) used for purposes of making claims more readable rather than specifying a sequence. Statements referring to “at least Z of A, B, and C,” and the like (e.g., “at least Z of A, B, or C”), refer to at least Z of the listed categories (A, B, and C) and do not require at least Z units in each category. Unless the context clearly indicates otherwise, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Furthermore, unless indicated otherwise, updating an item may include generating the item or modifying an existing time. Thus, updating a record may include generating a record or modifying the value of an already-generated value.

Unless the context clearly indicates otherwise, ordinal numbers used to denote an item do not define the item's position. For example, an item that may be a first item of a set of items even if the item is not the first item to have been added to the set of items or is otherwise indicated to be listed as the first item of an ordering of the set of items. Thus, for example, if a set of items is sorted in a sequence from “item 1,” “item 2,” and “item 3,” a first item of a set of items may be “item 2” unless otherwise stated.

The present techniques will be better understood with reference to the following enumerated embodiments:

1. A method comprising: obtaining, in a first runtime of a first application executing in the first runtime, a command to execute a second application; detecting, in metadata associated with the second application, an identifier; executing a second runtime in a container based on a runtime build identified by the identifier; and executing the second application in the second runtime.

2. A method comprising: in response to initializing an application in a first container runtime of a first container, obtaining, in the first container runtime, a set of commands to execute a first auxiliary application and a second auxiliary application; detecting, based on the set of commands, a first runtime identifier in first metadata associated with the first auxiliary application and a second runtime identifier in second metadata associated with the second auxiliary application; executing a second container runtime based on a first runtime build identified by the first runtime identifier and a third container runtime based on a second runtime build identified by the second runtime identifier by: initializing a second container and a third container; and executing the second container runtime in the second container and the third container runtime in the third container; and executing the first auxiliary application in the second container runtime and the second auxiliary application in the third container runtime.

3. The method of embodiment 2, wherein the first auxiliary application and the second auxiliary application are software dependencies of the application.

4. A method comprising: obtaining a command to execute an auxiliary application, wherein the command is caused by an execution of a primary application executing in a first container runtime of a first container; detecting, based on the command, an identifier in metadata associated with the auxiliary application; executing a second container runtime in a second container based on a runtime build identified by the identifier; and executing the auxiliary application in the second container runtime.

5. The method of any of embodiments 1 to 4, wherein the first application comprises at least one of an orchestrator component, a ledger component, and a mapping component.

6. The method of any of embodiments 1 to 5, wherein the container is a first container, further comprising executing a third runtime in a second container based on the runtime build.

7. The method of any of embodiments 1 to 6, wherein obtaining the command comprises obtaining the command in association with an account indicated to have credentials associated with the command.

8. The method of any of embodiments 1 to 7, wherein executing the second runtime comprises searching a repository to retrieve the runtime build based on the identifier of the runtime build.

9. The method of any of embodiments 1 to 8, further comprising: establishing an interoperability layer connecting the first runtime to the second runtime; and passing values from the second runtime to the first runtime via the interoperability layer.

10. The method of any of embodiments 1 to 9, wherein: the runtime build is a first runtime build; executing the second application comprises executing a third application; the operations further comprise: detecting, in metadata associated with the third application, an identifier of a second runtime build; and executing a third runtime based on the runtime build; and executing the third application in the third runtime.

11. The method of any of embodiments 1 to 10, further comprising encoding the runtime build based on a set of language bindings compatible with the first application.

12. The method of any of embodiments 1 to 11, wherein: the metadata of the second application indicates multiple runtime builds; the runtime build is a selected runtime build; and the operations further comprise determining, as the selected runtime build, a most recent runtime build or a most recent stable runtime build of the multiple runtime builds.

13. The method of any of embodiments 1 to 12, the operations further comprising: retrieving a first record history to obtain a second version of the first record history, wherein the first record history is managed by operations occurring in the first runtime; generating a second record history by updating the second version of the first history to indicate a first event associated with a first timepoint, wherein the first timepoint is not a most recent timepoint of the first record history; and updating the first record history based on the second record history.

14. The method of any of embodiments 1 to 13, wherein the auxiliary application is a first auxiliary application, and wherein the runtime build is a first runtime build, and wherein the command is a first command, further comprising: obtaining, in the first container runtime, a second command to execute a second auxiliary application; detecting, in metadata of the second auxiliary application, a second identifier of a second runtime build; and executing a third container runtime based on the second runtime build.

15. The method of embodiment 14, wherein the first container runtime is configured with a first set of credentials associated with a first account, and wherein the second container runtime is configured with a second set of credentials associated with a second account.

16. The method of any of embodiments 1 to 15, wherein executing the second container runtime comprises: obtaining an anticipated computing resource cost associated with a second auxiliary application; and executing the second container runtime in response to a result indicating that a computing resource threshold is not exceeded based on the anticipated computing resource cost.

17. The method of any of embodiments 1 to 16, further comprising storing application data of the auxiliary application into a cache accessible by the primary application, wherein executing the auxiliary application comprises loading the application data of the auxiliary application from the cache.

18. The method of any of embodiments 1 to 17, wherein the runtime build is a first runtime build, further comprising: building the first runtime build based on first source code; building a second runtime build based on second source code; and storing the first runtime build and the second runtime build in a repository, wherein executing the second container runtime comprises selecting the first runtime build from the repository based on the identifier.

19. The method of embodiment 18, further comprising deploying the first runtime build to be accessible to a user account without deploying the second runtime build to the user account.

20. The method of any of embodiments 1 to 18, wherein the command is a first command, wherein the auxiliary application is a first auxiliary application, further comprising: obtaining, in the first container runtime, a second command to execute a second auxiliary application; and executing the second auxiliary application in a third container runtime.

21. The method of embodiment 20, wherein executing the second auxiliary application comprises transferring data generated by the second auxiliary application to the first auxiliary application.

22. One or more tangible, non-transitory, machine-readable media storing instructions that, when executed by a set of processors, cause the set of processors to effectuate operations comprising those of any of embodiments 1-20.

23. A system comprising: a set of processors and a set of media storing computer program instructions that, when executed by the set of processors, cause the set of processors to effectuate operations comprising those of any of embodiments 1-20.

What is claimed is:

1. A system for decoupling runtimes of software dependencies by using application metadata of auxiliary applications to initialize different runtimes for the auxiliary applications, the system comprising one or more processors and one or more non-transitory media storing program instructions that, when executed by the one or more processors, perform operations comprising:
in response to initializing an application in a first container runtime of a first container, obtaining, in the first container runtime, a set of commands to execute a first auxiliary application and a second auxiliary application, wherein the first auxiliary application and the second auxiliary application are software dependencies of the application;
detecting, based on the set of commands, a first runtime identifier in first metadata associated with the first auxiliary application and a second runtime identifier in second metadata associated with the second auxiliary application;
executing a second container runtime based on a first runtime build identified by the first runtime identifier and a third container runtime based on a second runtime build identified by the second runtime identifier by:
initializing a second container and a third container; and
executing the second container runtime in the second container and the third container runtime in the third container; and
executing the first auxiliary application in the second container runtime and the second auxiliary application in the third container runtime.

2. A method comprising:
obtaining a command to execute an auxiliary application, wherein the command is caused by an execution of a primary application executing in a first container runtime of a first container;
detecting, based on the command, an identifier in metadata associated with the auxiliary application;
executing a second container runtime in a second container based on a runtime build identified by the identifier; and
executing the auxiliary application in the second container runtime.

3. The method of claim 2, wherein the auxiliary application is a first auxiliary application, and wherein the runtime build is a first runtime build, and wherein the command is a first command, further comprising:
obtaining, in the first container runtime, a second command to execute a second auxiliary application;
detecting, in metadata of the second auxiliary application, a second identifier of a second runtime build; and
executing a third container runtime based on the second runtime build.

4. The method of claim 3, wherein the first container runtime is configured with a first set of credentials associated with a first account, and wherein the second container runtime is configured with a second set of credentials associated with a second account.

5. The method of claim 2, wherein executing the second container runtime comprises:
obtaining an anticipated computing resource cost associated with a second auxiliary application; and
executing the second container runtime in response to a result indicating that a computing resource threshold is not exceeded based on the anticipated computing resource cost.

6. The method of claim 2, further comprising storing application data of the auxiliary application into a cache accessible by the primary application, wherein executing the auxiliary application comprises loading the application data of the auxiliary application from the cache.

7. The method of claim 2, wherein the runtime build is a first runtime build, further comprising:
building the first runtime build based on first source code;
building a second runtime build based on second source code; and
storing the first runtime build and the second runtime build in a repository, wherein executing the second container runtime comprises selecting the first runtime build from the repository based on the identifier.

8. The method of claim 7, further comprising deploying the first runtime build to be accessible to a user account without deploying the second runtime build to the user account.

9. The method of claim 2, wherein the command is a first command, wherein the auxiliary application is a first auxiliary application, further comprising:
obtaining, in the first container runtime, a second command to execute a second auxiliary application; and
executing the second auxiliary application in a third container runtime.

10. The method of claim 9, wherein executing the second auxiliary application comprises transferring data generated by the second auxiliary application to the first auxiliary application.

11. One or more non-transitory, machine-readable media storing program instructions that, when executed by one or more processors, causes the one or more processors to perform operations comprising:
obtaining, in a first runtime of a first application executing in the first runtime, a command to execute a second application;
detecting, in metadata associated with the second application, an identifier;
executing a second runtime in a container based on a runtime build identified by the identifier; and
executing the second application in the second runtime.

12. The one or more non-transitory, machine-readable media of claim 11, wherein the first application comprises at least one of an orchestrator component, a ledger component, and a mapping component.

13. The one or more non-transitory, machine-readable media of claim 11, wherein the container is a first container, further comprising executing a third runtime in a second container based on the runtime build.

14. The one or more non-transitory, machine-readable media of claim 11, wherein obtaining the command comprises obtaining the command in association with an account indicated to have credentials associated with the command.

15. The one or more non-transitory, machine-readable media of claim 11, wherein executing the second runtime comprises searching a repository to retrieve the runtime build based on the identifier of the runtime build.

16. The one or more non-transitory, machine-readable media of claim 11, further comprising:
establishing an interoperability layer connecting the first runtime to the second runtime; and
passing values from the second runtime to the first runtime via the interoperability layer.

17. The one or more non-transitory, machine-readable media of claim 11, wherein:
the runtime build is a first runtime build;
executing the second application comprises executing a third application; and
the operations further comprise:
detecting, in metadata associated with the third application, an identifier of a second runtime build;
executing a third runtime based on the runtime build; and
executing the third application in the third runtime.

18. The one or more non-transitory, machine-readable media of claim 11, further comprising encoding the runtime build based on a set of language bindings compatible with the first application.

19. The one or more non-transitory, machine-readable media of claim 11, wherein:
the metadata of the second application indicates multiple runtime builds;
the runtime build is a selected runtime build; and
the operations further comprise determining, as the selected runtime build, a most recent runtime build or a most recent stable runtime build of the multiple runtime builds.

20. The one or more non-transitory, machine-readable media of claim 11, the operations further comprising:
retrieving a first record history to obtain a second version of the first record history, wherein the first record history is managed by operations occurring in the first runtime;
generating a second record history by updating the second version of the first record history to indicate a first event associated with a first timepoint, wherein the first timepoint is not a most recent timepoint of the first record history; and
updating the first record history based on the second record history.
